(19) United States
(12) Patent Application Publication
(10) Pub. No.: US 2006/0047785 A1
(43) Pub. Date: Mar. 2, 2006

(54) System and method for configuring and managing communication devices

(75) Inventors: Jain-Chung Wang, Tu-Cheng (TW); Chuan-Cheng Hsu, Tu-Cheng (TW)

Correspondence Address: MORRIS MANNING & MARTIN LLP, 1600 ATLANTA FINANCIAL CENTER, 3343 PEACHTREE ROAD, NE, ATLANTA, GA, 30326-1044, US

(73) Assignee: HON HAI Precision Industry CO., LTD., Tu-Cheng City (TW)

(21) Appl. No.: 10/996,822

(22) Filed: Nov. 24, 2004

(30) Foreign Application Priority Data
Jun. 18, 2004 (TW) 93117718

(51) Int. Cl. G06F 15/177

(52) U.S. Cl. 709/220

(57) ABSTRACT

A system (3) for configuring and managing communication devices that include non-volatile memories includes a user interface (31) for providing a configuration and management interface for a network administrator, one or more service modules (35) for generating configuration information, and a configuration manager (33) for managing the configuration information. The user interface includes a parser (312) for parsing configuration commands or management commands issued by the network administrator. The configuration manager includes a command builder (334) for mapping the configuration information provided by the service modules to the configuration commands, and a command loader (332) for loading respective configuration files containing the configuration commands from the non-volatile memories of the communication devices. A related method for configuring and managing communication devices is also disclosed.

### BACKGROUND OF THE INVENTION

1. Field of the Invention

The present invention pertains to systems and methods for configuring and managing communication devices.

2. Description of Related Art

With the ongoing development of electronic communication networks, communication devices such as bridges, switches, routers and gateways have proliferated. Network clients access a local area network (LAN) such as an intranet or a wide area network (WAN) such as the Internet by use of the communication devices. Consequently, the communication devices play a very important role in network communications. If any one of the communication devices has a network malfunction, the entire communication network may break down.

In order to ensure that the communication devices can operate smoothly, it is necessary to properly configure them and thereafter properly manage the corresponding configuration information. The configuration information is a set of parameters that control operation of the communication devices. A network administrator configures the communication devices by setting the corresponding configuration information thereof. In addition, a topological structure of the electronic communication network varies when, for example, the number of network clients is changed. Thus the network administrator needs to browse, edit and save the configuration information from time to time. In this way, the configuration information of the communication devices can correspond appropriately to the topological structure of the electronic communication network at any given time. What is needed is a system and method which assist the network administrator to configure and manage the communication devices.

### SUMMARY OF THE INVENTION

Accordingly, a primary object of the present invention is to provide a system for facilitating a network administrator to configure and manage communication devices.

A secondary object of the present invention is to provide a method for facilitating a network administrator to configure and manage communication devices.

In order to fulfill the above-mentioned primary object, the present invention provides a system for configuring and managing communication devices that comprise non-volatile memories. The system comprises a user interface for providing a configuration and management interface for a network administrator, at least one service module for generating configuration information, and a configuration manager for managing the configuration information. The user interface comprises a parser for parsing configuration commands and management commands issued by the network administrator. The configuration manager comprises a command builder for mapping the configuration information provided by the service modules to the configuration commands, and a command loader for loading respective configuration files containing the configuration commands from the non-volatile memories of the communication devices.

In order to fulfill the above-mentioned secondary object, the present invention provides a method for configuring and managing communication devices that comprise non-volatile memories. The method comprises the following steps: (a) parsing configuration commands; (b) determining whether a user interface received a save command; (c) mapping configuration information transmitted by a configuration agent sub-module of a service module to the configuration commands, if the user interface received a save command; and (d) saving the configuration commands in the non-volatile memories of the communication devices by way of a storage manager.

Other objects, advantages and novel features of the present invention will become more apparent from the following detailed description when taken in conjunction with the accompanying drawings, in which:

### BRIEF DESCRIPTION OF THE DRAWINGS

FIG. 1 is a schematic diagram of architecture of an exemplary system for configuring and managing communication devices according to the present invention;

FIG. 2 is a diagram showing a mapping relationship between three configuration control blocks of a Routing Information Protocol (RIP) module of the system of FIG. 1 and equivalent sets of Command Line Interface (CLI) commands;

FIG. 3 is a diagram showing a mapping relationship between fields of an interface configuration control block of the RIP module of FIG. 2 and the CLI commands; and

FIG. 4 is a flow chart of an exemplary method for configuring and managing communication devices according to the present invention.

### DETAILED DESCRIPTION OF THE INVENTION

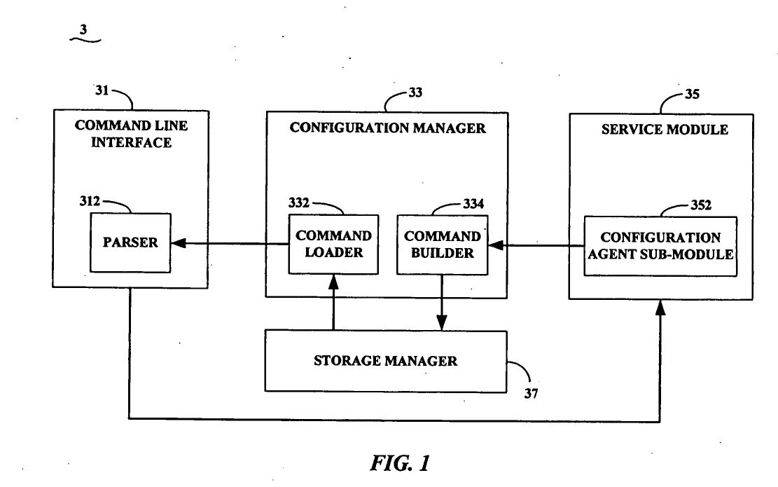

FIG. 1 is a schematic diagram of architecture of an exemplary system 3 for configuring and managing communication devices according to the present invention. In the preferred embodiment of the present invention, the system 3 comprises a Command Line Interface (CLI) 31 for providing a configuration and management interface for a network administrator, a configuration manager 33 for providing configuration files for the CLI 31, one or more service modules 35 for providing configuration information for the configuration manager 33, and a storage manager 37 for saving the configuration files.

In an alternative embodiment, the CLI 31 may be replaced by a web interface. A configuration file is a collection of configuration commands for configuring a particular communication device. The configuration commands can include CLI commands, and command menus applied to the web interface. In the preferred embodiment of the present invention, the below-mentioned configuration commands only refer to CLI commands. The CLI 31 comprises a parser 312 for parsing the CLI commands. The configuration manager 33 comprises a command loader 332 and a command builder 334. The command loader 332 is used for loading the configuration files from non-volatile memories of the communication devices via the storage manager 37, and for transmitting the loaded configuration files to the parser 312. The command builder 334 is used for mapping the configuration information to an equivalent set of the CLI commands, and for saving the CLI commands in the non-volatile memories of the communication devices through the storage manager 37. The service module 35 includes one or more configuration control blocks (not shown in FIG. 1) that contain the configuration information. The service module 35 comprises a configuration agent sub-module 352 for transmitting the configuration control blocks to the command builder 334. The service module 35 may be a Routing Information Protocol (RIP) module, a Virtual Local Area Network (VLAN) module, a Dynamic Host Configuration Protocol (DHCP) module or a like module of the communication devices. Configuration of the communication devices is equivalent to configuration of the service module 35 of the communication devices.

When the network administrator issues the configuration commands through the CLI 31, the parser 312 parses the configuration commands so as to configure the service module 35. If the network administrator does not issue a save command, the configuration information about the service module 35 is not saved, and is lost when the communication devices restart. If the network administrator issues a save command, the configuration manager 33 collects the configuration information about the service module 35 from the communication devices. The configuration agent sub-module 352 transmits the configuration control block that contains the configuration information about the service module 35 to the command builder 334. The command builder 334 maps the configuration control block to the equivalent set of CLI commands, and saves the equivalent set of CLI commands as respective configuration files in the non-volatile memories of the communication devices through the storage manager 37.

When the network administrator issues a browse command through the CLI 31, the command loader 332 loads the configuration files from the non-volatile memories of the communication devices through the storage manager 37, and then transmits the loaded configuration files to the CLI 31. In such case, the network administrator can browse the configuration information about the communication devices, and determine whether to reconfigure the communication devices according to practical requirements. If the network administrator issues a reconfiguration command through the CLI 31, the parser 312 re-parses the configuration commands in the configuration files.

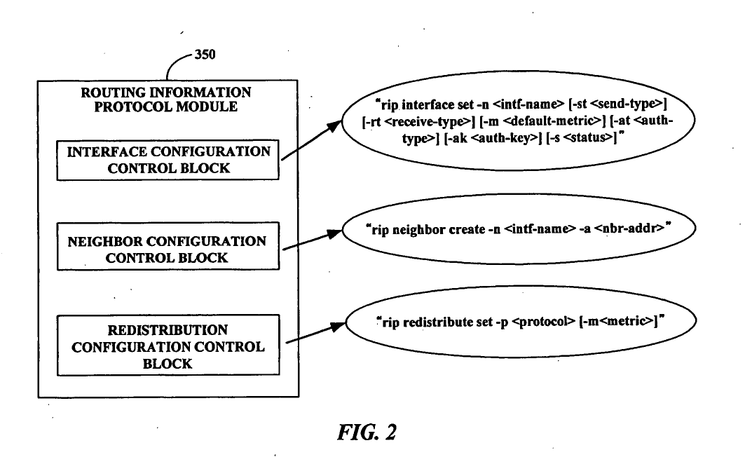

Each configuration control block is mapped to an equivalent set of CLI commands. FIG. 2 is a diagram showing a mapping relationship between three configuration control blocks of a Routing Information Protocol (RIP) module 350 and the equivalent sets of CLI commands. The RIP module 350 includes an interface configuration control block, a neighbor configuration control block, and a redistribution configuration control block. The interface configuration control block is mapped to the following set of the CLI commands: rip interface set -n <intf-name> [-st <send-type>] [-rt <receive-type>] [-m <default-metric>] [-at <auth-type>] [-ak <auth-key>] [-s <status>]. The neighbor configuration control block is mapped to the following set of the CLI commands: rip neighbor create -n <intf-name> -a <nbr-addr>. The redistribution configuration control block is mapped to the following set of the CLI commands: rip redistribute set -p <protocol> [-m<metric>].

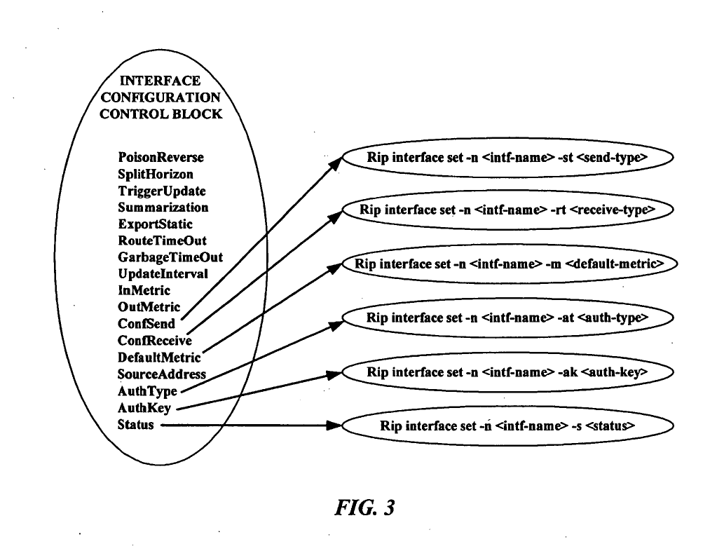

Each configuration control block has its own individual number of fields. If a field of the configuration control block has a correspondingly mapped CLI command, the field is mapped only to that CLI command and no other CLI command. Further, no other field is mapped to the same CLI command. Not all the fields of the configuration control block have a correspondingly mapped CLI commands. FIG. 3 is a diagram showing a mapping relationship between the fields of the interface configuration control block and the CLI commands. The interface configuration control block has seventeen different fields. Six of the seventeen fields have correspondingly mapped CLI commands, while the other fields are used internally in the system 3 without correspondingly mapped CLI commands. For example: a “ConfSend” field corresponds to the following CLI command: Rip interface set -n <intf-name> -st <send-type>; a “ConfReceive” field corresponds to the following CLI command: Rip interface set -n <intf-name> -rt <receive-type>; a “DefaultMetric” field corresponds to the following CLI command: Rip interface set -n <intf-name> -m <default-metric>; an “AuthType” field corresponds to the following CLI command: Rip interface set -n <intf-name> -at <auth-type>; an “AuthKey” field corresponds to the following CLI command: Rip interface set -n <intf-name> -ak <auth-key>; and a “Status” field corresponds to the following CLI command: Rip interface set -n <intf-name> -s <status>.

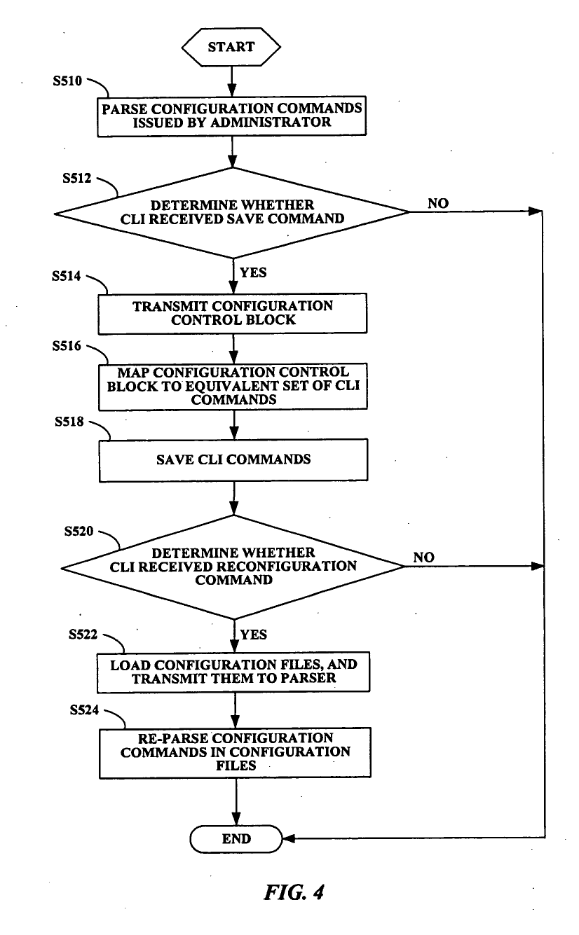

FIG. 4 is a flow chart of an exemplary method for configuring and managing communication devices according to the present invention. An administrator configures and manages the communication devices through the CLI 31. At step S510, the parser 312 parses the configuration commands issued by the network administrator so as to configure the service module 35. At step S512, the parser 312 determines whether the CLI 31 received a save command issued by the network administrator. If so, the procedure goes to step S514. Otherwise, the procedure is finished. At step S514, according to the save command, the configuration agent sub-module 352 of the service module 35 transmits one or more configuration control blocks to the command builder 334. At step S516, the command builder 334 maps the configuration control blocks to an equivalent set of CLI commands. At step S518, the command builder 334 saves the equivalent set of CLI commands as respective configuration files in the non-volatile memories of the communication devices through the storage manager 37. At step S520, the parser 312 determines whether the CLI 31 received a reconfiguration command issued by the network administrator. If so, the procedure goes to step S522. Otherwise, the procedure is finished. At step S522, the command loader 332 loads the configuration files from the non-volatile memories of the communication devices through the storage manager 37, and then transmits them to the parser 312. At step S524, the parser 312 re-parses the configuration commands in the configuration files, whereupon the procedure is finished.

While various embodiments and a method of the present invention have been described above, it should be understood that they have been presented by way of example only and not by way of limitation. Thus the breadth and scope of the present invention should not be limited by the above-described exemplary embodiments and method, but should be defined only in accordance with the following claims and their equivalents.

What is claimed is:

1. A system for configuring and managing communication devices that comprise non-volatile memories, the system comprising:
a user interface for providing a configuration and management interface, the user interface comprising a parser for parsing configuration commands and management commands;
at least one service module for generating configuration information after the parser parses the configuration commands; and
a configuration manager for managing the configuration information, the configuration manager comprising:
a command builder for mapping the configuration information provided by said service module to the configuration commands; and
a command loader for loading configuration files from the non-volatile memories of the communication devices.

2. The system as claimed in claim 1, wherein the user interface is a Command Line Interface (CLI).

3. The system as claimed in claim 1, wherein the user interface is a web interface.

4. The system as claimed in claim 1, wherein said service module comprises a configuration agent sub-module for providing the configuration information to the command builder.

5. The system as claimed in claim 1, further comprising a storage manager for saving the configuration information in the non-volatile memories of the communication devices.

6. The system as claimed in claim 5, wherein the command builder saves the configuration commands as respective configuration files in the non-volatile memories of the communication devices by way of the storage manager.

7. The system as claimed in claim 5, wherein the command loader loads the configuration files from the non-volatile memories of the communication devices by way of the storage manager.

8. A system for configuring and managing communication devices that comprise non-volatile memories, the system comprising:
a user interface for providing a configuration and management interface, the user interface comprising a parser for parsing configuration commands and management commands;
at least one service module for generating configuration information after the parser parses the configuration commands;
a storage manager; and
a configuration manager for managing the configuration information, the configuration manager comprising:
a command builder for mapping the configuration information provided by said service module to the configuration commands, and for saving the configuration commands as respective configuration files in the non-volatile memories of the communication devices by way of the storage manager; and
a command loader for loading the configuration files from the non-volatile memories of the communication devices by way of the storage manager.

9. The system as claimed in claim 8, wherein the user interface is a Command Line Interface (CLI).

10. The system as claimed in claim 8, wherein the user interface is a web interface.

11. The system as claimed in claim 8, wherein said service module comprises a configuration agent sub-module for providing the configuration information to the command builder.

12. A method for configuring and managing communication devices that comprise non-volatile memories, the method comprising the following steps:
(a) parsing configuration commands;
(b) determining whether a user interface received a save command;
(c) mapping configuration information transmitted by a configuration agent sub-module of a service module to the configuration commands, if the user interface received a save command; and
(d) saving the configuration commands in the non-volatile memories of the communication devices by way of a storage manager.

13. The method as claimed in claim 12, further comprising the following steps:
(e) determining whether the user interface received a reconfiguration command;
(f) loading the configuration commands from the non-volatile memories of the communication devices by way of the storage manager and transmitting the configuration commands to a parser, if the user interface received a reconfiguration command; and
(g) re-parsing the configuration commands.

14. The method as claimed in claim 13, wherein the user interface is a command line interface (CLI) or a web interface.

15. A method for managing communication devices and configuration information thereof, comprising the steps of:
providing a user interface;
retrieving user-defined commands via said user interface;
parsing said commands to configure said communication devices; and
retrieving said configuration information based on a post-command situation of said communication devices.

16. The method as claimed in claim 15, further comprising the step of saving said configuration information by means of mapping said configuration information to corresponding commands so as to save said corresponding commands as a file.

17. The method as claimed in claim 16, further comprising the step of reconfiguring said corresponding commands by means of opening said file of said corresponding commands and re-parsing said corresponding commands based on newly retrieved configuration information.
